(19) United States
(12) Patent Application Publication
(10) Pub. No.: US 2015/0083171 A1
(43) Pub. Date: Mar. 26, 2015

(54) METHOD AND APPARATUS FOR TREATING AT LEAST ONE SUBSTRATE IN A LIQUID MEDIUM

(71) Applicant: AWT ADVANCED WET TECHNOLOGIES GmbH, Hüfingen (DE)

(72) Inventors: Hans Hauger, Donaueschingen (DE); Werner Schulz, Aalen (DE)

(73) Assignee: AWT ADVANCED WET TECHNOLOGIES GMBH, Hüfingen (DE)

(21) Appl. No.: 14/397,338

(22) PCT Filed: Apr. 26, 2013
(86) PCT No.: PCT/EP2013/058687

§ 371 Date: Oct. 27, 2014

(30) Foreign Application Priority Data
Apr. 27, 2012 (DE) 10 2012 103 762.0
Mar. 13, 2013 (DE) 10 2013 102 545.5

(51) Int. Cl. B08B 3/04

(52) U.S. Cl. CPC B08B 3/04
USPC 134/157

(57) ABSTRACT

A method for treating at least one substrate (15), particularly wafers, in a liquid medium (3). In a first step, the substrate (15) is lifted in the liquid medium (3) until the substrate (15) is at least partially lifted out of the liquid medium (3) and, in a second step, is passed on at least one point protruding out of the liquid medium (3).

### BACKGROUND OF THE INVENTION

The invention relates to a method for treating at least one substrate, in particular wafers, in a liquid medium, and to an apparatus for this purpose.

This invention relates to a technology, by way of which, in particular, optimum drying of substrates is possible. Substrates are, inter alia, base plates for semiconductors or electronic components. These are wafers. However, this applies only by way of example. The invention also relates to other substrates or articles which are removed from a bath, no matter what shape, whether round, angular, oval or the like, and no matter from what material.

This application relates, above all, to a method, in which a wafer is dipped into a liquid bath, is subsequently raised up from said liquid bath at a slow raising speed, and is dried by way of a gas mixture, usually Isopropanol/N₂ mixture. This cleaning method uses the physical properties of the Marangoni effect, the properties of the gas nitrogen N₂ and the properties of the alcohol Isopropanol IPA. The Marangoni effect is based on targeted control of the flow of fluid. Here, the internal stress in a medium is utilized or increased in such a way that said internal stress or generated internal stress is greater than the interface stress between a fluid and a surface, with the result that the fluid flows along the interface to the greater stress and therefore dries without residue and without contact.

US 2009/0084413 A1 has disclosed a drying module for wafers, a lift device being provided, by way of which the corresponding wafer or the substrate can be moved in the drying chamber.

In the prior art, U.S. Pat. No. 4,772,752 describes a method for cleaning silicon sheets. Here, a silicon sheet is dipped into a liquid medium which contains deionized water which is heated to 90° C. Subsequently, the sheet is removed from the medium at a slow movement speed, with the result that the sheet dries while exiting. A disadvantage in the drying process has resulted from said method. The heat of the deionized water which is heated to 90° C. passes to the silicon sheet. Since, during exiting, there is still a fine film of the liquid medium on the surface of the silicon sheet until it dries as a result of evaporation of the water, contaminants from the liquid medium likewise also dry on the silicon sheet surface. This type of drying traces and contaminants can have a very disadvantageous effect on the further processing of the silicon sheets.

DE 690 12 373 T2 likewise describes a method and an apparatus which serves to dry substrates, which method takes place after treatment in a liquid. Here, the difference lies in the fact that the substrate is brought directly into contact with a gas vapor when leaving the liquid bath. Said gas consists of a mixture which leads to the Marangoni effect.

Said method and the first-mentioned method have one disadvantage. In both methods, the apparatus is designed in such a way that a bath with a liquid medium is provided, into which bath a substrate (silicon sheet or wafer) is dipped and is then conveyed out of the bath by means of mechanical elements for drying, either by way of a gas/vapor mixture or by way of inherent heat.

Similar methods and/or apparatuses are also described in US 2002/0023668 A1, WO 2008/033861 A2 and US 2003/0168086 A1. In every case, a liquid bath is assigned a drying chamber or drying device. Either the same supporting device serves to move the substrate from the treatment chamber into the drying chamber, or else, above it, a corresponding supporting device is assigned a dedicated lift, by way of which the substrate can be removed from the lifting unit.

The problem here and a subsequent disadvantage are the mechanical conveying systems. In said conveying systems, action points or contact points exist between the substrate and raising mechanism. Said contact points impede the effectiveness of the Marangoni effect and, after drying, have drying traces of dried contaminants which have a disadvantageous effect on the subsequent processes and the functionality of the product.

It is an object of this invention to eliminate the disadvantages which arise from the prior art and, in particular, to make contactless drying possible.

### SUMMARY OF THE INVENTION

The foregoing object is achieved by the present invention where a substrate is dipped into a basin which is filled with a liquid medium. The dipping into the basin takes place via a mechanism. Said mechanism is preferably a lifting drive, by way of which precise positioning can be carried out. In the present exemplary embodiment, the lifting drive consists of two lifting units, each lifting unit being connected to a carriage. Said carriages are arranged one above another on a guide column and move along the guide column. The movement of said carriages can take place on any desired type of drive; a stepping motor is preferred.

According to the invention, the two carriages are connected to one another via a toggle lever arrangement which is designed in such a way that it can change a spacing of the two carriages from one another. As a result, the position of two supporting limbs which are a constituent part of the lifting units is changed with respect to one another.

A holding frame with stops, on which the substrate can be placed, is situated on one of the supporting limbs. Supporting elements, by way of which the substrate can be raised up from the stops, protrude upward from the supporting limb of the other lifting unit.

The method according to the invention then comprises the following working steps:

As first working or method step, the substrate is lowered into the liquid medium and is thus treated with the liquid medium.

Next, the substrate is raised up entirely or only partially from the liquid medium. In preferred exemplary embodiments, it is raised up at least half out of the medium. The lifting speed during the raising is preferably selected in such a way that a Marangoni effect is produced between the substrate and the liquid medium at the moment of exiting. The frictional force which is produced from the lifting speed preferably must not exceed the adhesion force which is produced from the internal stress of the liquid, in order that the Marangoni effect is not interrupted. Raising up by way of initiating and taking the Marangoni effect into consideration has the advantage that the risk of drying traces is virtually minimized, preferably is eliminated.

As next working or method step, the substrate is accepted by the supporting elements and is raised up from the stops. However, the acceptance takes place at points of the substrate which are already dry, with the result that no more traces at all remain on the substrate. It is of course to be assumed here that the supporting elements are also already dry when they accept the substrate, that is to say the liquid medium has run off at least from the point which acts on the substrate. Said method step has the advantage that the substrate is accepted at a dried point by a dry supporting element, with the result that the production of drying traces is no longer possible at the contact points.

The supporting elements can be of any desired configuration. It is of course also conceived within the scope of the invention that the lifting units do not move at a different speed, but rather at the same speed, and are arranged on a single carriage, for example. In this case, the supporting elements are then configured such that they can be extended telescopically.

However, the abovementioned toggle lever arrangement is preferred which ensures that the lifting units move at a different speed at least partially, with the result that the acceptance of the substrate by one lifting unit from the other lifting unit is ensured, without it being necessary for the raising of the substrate out of the liquid medium to be interrupted. This also means at the same time that the Marangoni effect is not interrupted.

By way of said method, substrates of all types are raised from the liquid after cleaning, and contactless drying is ensured, drying traces also being avoided on action points. Wafers are preferably dried, but any object made from any material can be cleaned and dried by way of said apparatus and said method. During drying of wafers, the production of rejects is advantageously minimized, more rapid drying is possible, the consumption of Isopropanol and nitrogen is reduced by up to 50%, and the consumption of deionized water is reduced by up to 80%. The drying takes place approximately twice as rapidly as previously.

### BRIEF DESCRIPTION OF THE DRAWINGS

Further advantages, features and details of the invention result from the following description of preferred exemplary embodiments and using the drawing, in which:

FIG. 1 shows a diagrammatic view of an apparatus according to the invention in a starting position;

FIG. 2 to FIG. 4 show a diagrammatic view of the apparatus according to the invention in different use positions; and

FIG. 5 shows a diagrammatic view of the apparatus according to the invention in the end position.

### DETAILED DESCRIPTION

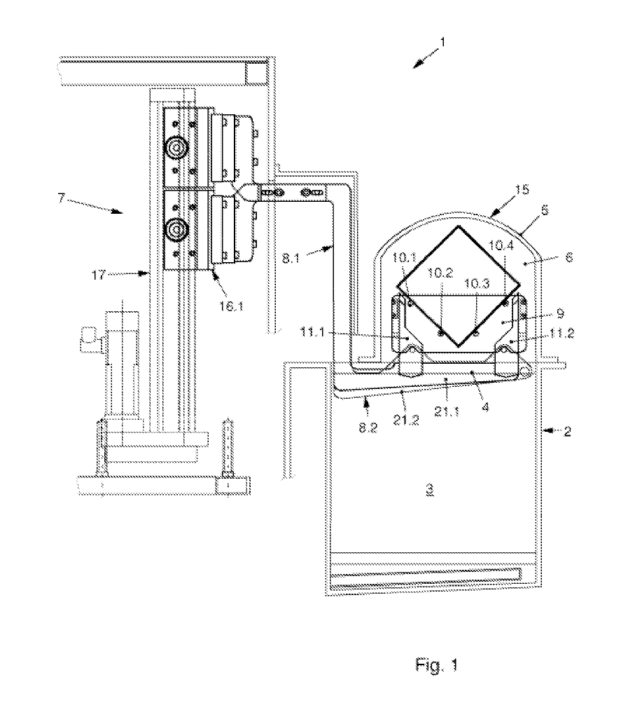

According to FIG. 1, an apparatus 1 for treating a substrate 15 in a liquid medium 3 consists of two housing parts. The first housing part is a basin 2 for the liquid medium 3. The basin 2 is filled with the liquid medium 3 up to a liquid level 4. The second housing part is placed on the basin 2 as a hood 5 which is filled with a gaseous medium 6.

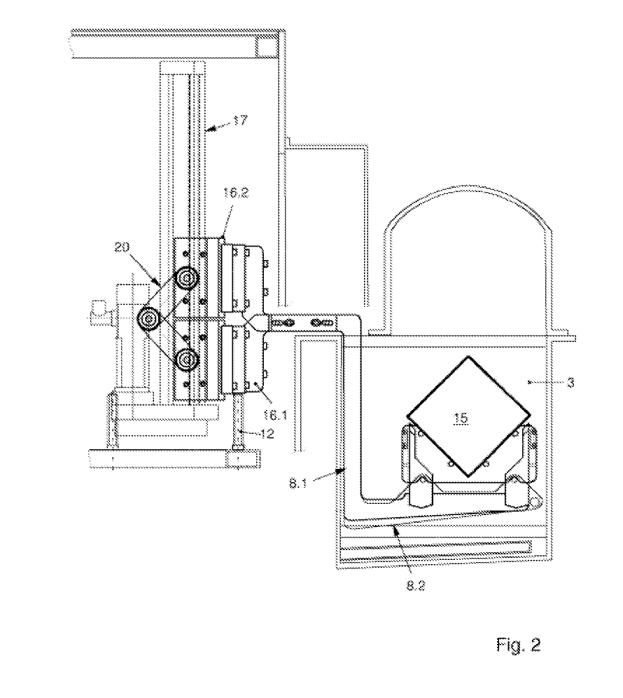

There is a lifting drive 7 for two lifting units 8.1, 8.2 in the apparatus 1. The lifting units 8.1 and 8.2 are connected to in each case one carriage 16.1 and 16.2 which are arranged so as to run above one another on a corresponding guide column 17. Here, their movements are coupled to one another, to be precise via a toggle lever arrangement 20 which is shown in FIG. 2. Said toggle lever arrangement 20 is not shown in the other figures for the sake of clarity.

Each lifting unit 8.1 and 8.2 is of approximately L-shaped configuration and has a supporting limb 21.1 and 21.2, an inner supporting limb 21.2 or optionally a plurality of inner supporting limbs being arranged between two outer supporting limbs 21.1.

A holding frame 9 is arranged on the inner supporting limb 21.2, on which holding frame 9 fixed stops 10.1 to 10.4 are provided as receptacles or holders for the substrate 15. The substrate 15 which is tilted by 45° is held in the holding frame by way of the four stops 10.1 to 10.4. Two supporting elements 11.1 and 11.2 are seated on the supporting limb 21.1.

The method of operation of the present invention is as follows:

FIG. 1 shows a starting position of the apparatus when carrying out the method according to the invention, the lifting drive 7 having been moved upward and the substrate 15 being situated outside the liquid medium 3 and therefore in the gaseous medium 6.

In this position, the holding frame 9 is also loaded with the substrate 15.

In a first method step according to FIG. 2, the two carriages 16.1 and 16.2 are then moved downward along the guide column 17 until the carriage 16.1 rests on a stop 12. In this end position, the lifting units 8.1 and 8.2 are lowered into the liquid medium 3 and the substrate 15 is likewise situated in the liquid medium. The substrate 15 is still seated on the stops 10.1 to 10.4.

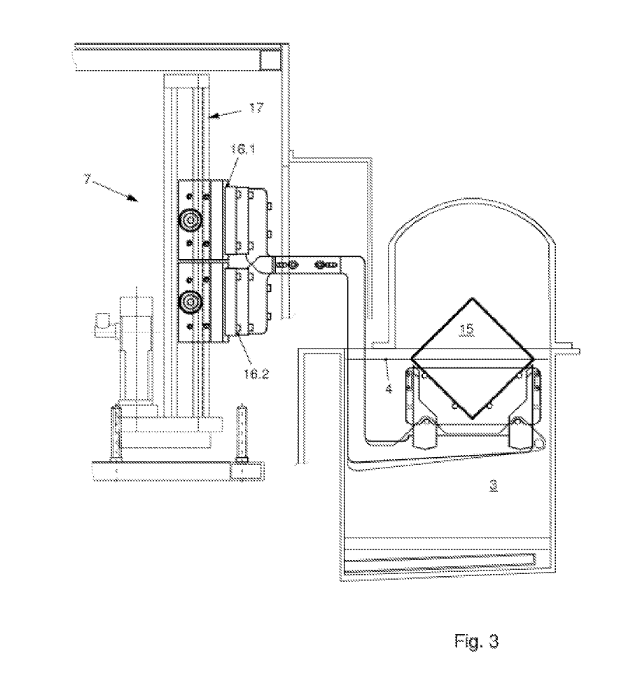

FIG. 3 shows that the lifting drive 7 with the carriages 16.1 and 16.2 is then moved upward along the guide column 17 until approximately half the substrate has been raised out of the liquid medium 3. As a consequence of the Marangoni effect, that part of the substrate which protrudes beyond the liquid level 4 of the liquid medium 3 is already dry.

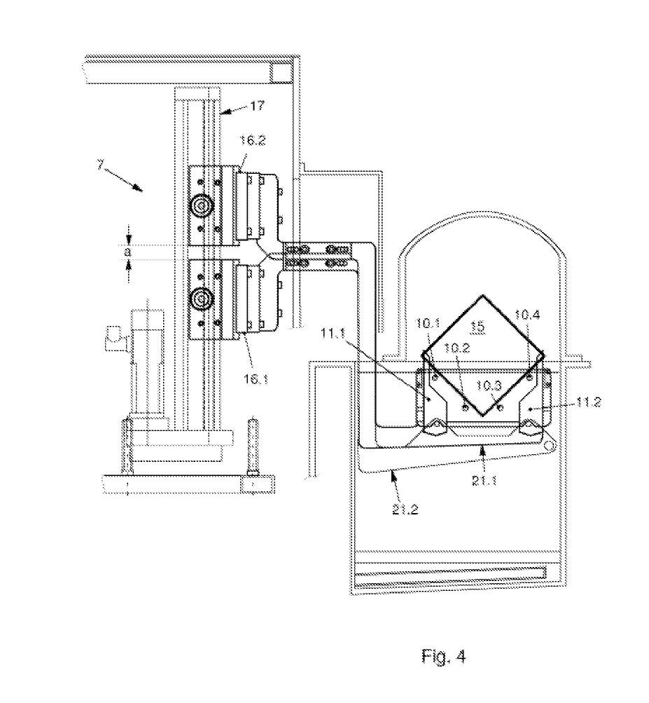

Without coming to a standstill, the lifting drive 7 moves further upward along the guide column 17, the toggle lever arrangement 20 being set in operation by way of a corresponding controller according to FIG. 4, however, with the result that the carriage 16.2 moves away from the carriage 16.1. As a result, a spacing a is produced between the two carriages 16.1 and 16.2. At the same time, the supporting limb 21.1 also overtakes the supporting limb 21.2, the two supporting elements 11.1 and 11.2 raising the substrate 15 up from the stops 10.1 to 10.4. Here, however, the supporting elements 11.1 and 11.2 act on the substrate 15 in edge regions of the latter which are already dry.

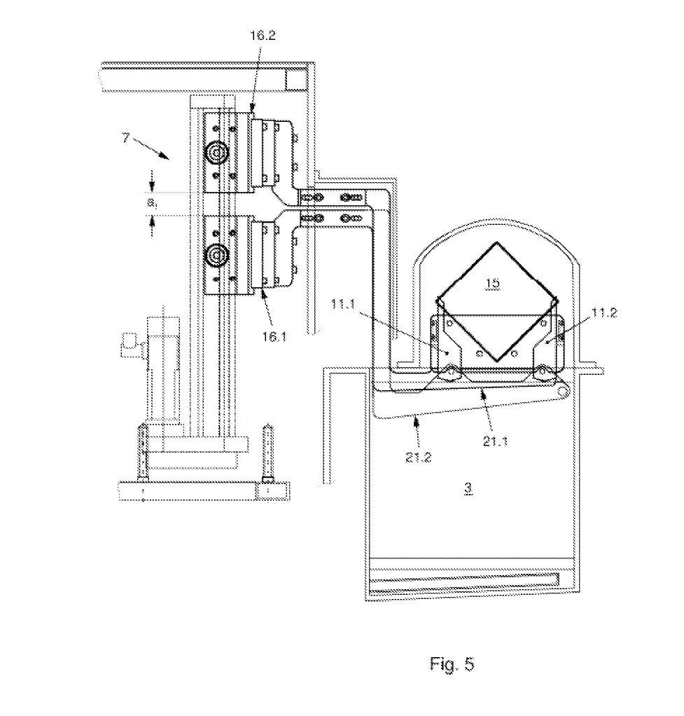

FIG. 5 then shows the other end position of the lifting drive 7, in which other end position the two carriages 16.1 and 16.2 have been moved further away from one another via the toggle lever arrangement 20, with the result that they maintain a spacing a1 from one another. The substrate 15 is raised entirely out of the liquid medium 3 by way of the supporting elements 11.1 and 11.2. As a consequence of the Marangoni effect, the entire liquid medium 3 has run off from the substrate 15. The substrate 15 does not have any visible supporting points at all. Supporting points of this type have been produced neither by the supporting elements 11.1 nor by the stops 10.1 to 10.4.

1-10. (canceled)

11. An apparatus for treating a substrate (15) in a liquid medium (3), comprising:
at least two lifting units (8.1, 8.2) are provided in the liquid medium below a substrate, the first lifting unit (8.1) is provided for raising the substrate (15) in the liquid medium (3) at a lifting speed which is selected in such a way that a Marangoni effect occurs between the substrate and the liquid medium at the moment of exiting from the liquid medium, until the substrate (15) has been raised at least partially out of the liquid medium (3), and wherein the second lifting unit (8.1) accepts the substrate (15) from the first lifting unit (8.2) when the substrate protrudes at least partially out of the liquid medium (3).

12. The apparatus as claimed in claim 11, wherein the first lifting unit (8.2) comprises a holding frame (9) for the substrate (15).

13. The apparatus as claimed in claim 12, wherein the first lifting unit (8.2) comprises a supporting limb (21.2) on which the holding frame (9) is arranged.

14. The apparatus as claimed in claim 13, wherein the substrate (15) is held in the holding frame (9) by stops (10.1-10.4).

15. The apparatus as claimed in claim 11, wherein at least one supporting element (11.1, 11.2) is arranged on the second lifting unit (8.1).

16. The apparatus as claimed in claim 11, including means for moving the second lifting unit (8.1) independently of the first lifting unit (8.2) and, optionally, at a different speed but on the same axis.

17. The apparatus as claimed in claim 11, wherein the lifting units (8.1, 8.2) comprise, in each case, one carriage (16.1, 16.2).

18. The apparatus as claimed in claim 17, wherein the carriages (16.1, 16.2) are connected to one another by way of a toggle lever arrangement (20).

19. The apparatus as claimed in claim 18, wherein the carriages (16.1, 16.2) are arranged on a guide column (17).
